(19) United States
(12) Patent Application Publication
(10) Pub. No.: US 2010/0005480 A1
(43) Pub. Date: Jan. 7, 2010

(54) METHOD FOR VIRTUAL WORLD EVENT NOTIFICATION

(75) Inventors: Vandana Mallempati, Austin, TX (US); Ruthie D. Lyle, Durham, NC (US); Angela Richards Jones, Durham, NC (US)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/168,240

(22) Filed: Jul. 7, 2008

(51) Int. Cl. G06F 3/00

(52) U.S. Cl. 719/318

(57) ABSTRACT

The present disclosure a method for providing virtual world event notification. A method for providing virtual world event notification may include receiving information regarding a virtual world event, receiving a user profile, determining if the virtual world event would be of interest to a particular user based upon the user profile, and inviting a user to the virtual world event based upon the user profile through a user's calendar application.

### TECHNICAL FIELD

The present disclosure generally relates to the field of computer technology and more particularly to a method for virtual world event notification.

### BACKGROUND

A virtual world application is a worldwide network-based simulation environment intended for users to inhabit and interact with avatars. A virtual world may include computer conferencing and text-based chat rooms. Events may be scheduled in virtual world applications, such as Second Life, through an interface provided by the virtual world application. Users of the virtual world application may view current and future events from a calendar provided in the virtual world application. The process of finding scheduled events that a user may be interested is a manual and tedious process.

### SUMMARY

The present disclosure is directed to a method for providing virtual world event notification. A method for providing virtual world event notification may include receiving information regarding a virtual world event, receiving a user profile, determining if the virtual world event would be of interest to a user based upon the user profile, and inviting a user to the virtual world event based upon the user profile through a user's calendar application.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 depicts a flow chart of a method for providing virtual world event notification.

### DETAILED DESCRIPTION

Reference will now be made in detail to the subject matter disclosed, which is illustrated in the accompanying drawings.

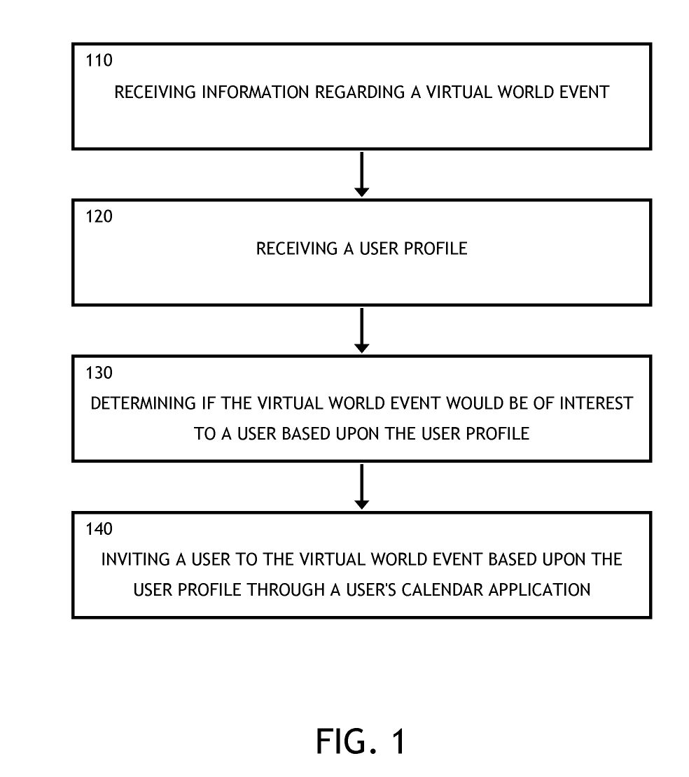

The present disclosure is directed to a method for providing virtual world event notification. Referring to FIG. 1, a flow chart of a method for providing virtual world event notification is shown. A method for providing virtual world event notification may include receiving information regarding a virtual world event 110. Information regarding a virtual world event may include a date and time of a virtual world event. Information regarding a virtual world event may include attributes of the event, including the type of event, length of the event, and the like. Method may further include receiving a user profile 120. The user profile may include a user's calendar information and attributes of virtual world events in which a user is interested. Method may include determining if the virtual world event would be of interest to a user based upon the user profile 130. For example, attributes selected within a user profile may be matched with attributes of a virtual world event to determine if a user may be interested in a particular virtual world event. Method may include inviting a user to the virtual world event based upon the user profile through a user's calendar application 140.

Virtual world users may subscribe to a notification service. This service may be provided by the virtual world application or an external vendor. It is contemplated that the notification service may execute a method for providing virtual world event notification as shown in FIG. 1. Currently, virtual world applications allow users to create a profile. For users of the notification service, a user profile may be extended to allow users to specify their preferences regarding events, and also to specify their calendar application of choice which is supported by the virtual world application. For example, Lotus Notes, Microsoft Outlook, Yahoo and the like may be calendar applications supported by a virtual world application.

When events are added to the virtual world application's calendar of events, attributes of that event may be compared to user profiles of users to determine if the user may be interested in that event. If the event is deemed to be of possible interest to the user, an event invitation is sent to the user's calendar application that is specified in their profile.

If there are overlapping events that may be of interest, the service will consider the order of preferences of the user to weigh the events and make a recommendation to the user on which one may be of more interest. Upon receiving the invitation, the user may interact with it just as they do all invitations (accept, reject, and the like).

After attending events, users may provide ratings on the event specifying if they liked or disliked the event type, host, or other attributes of the event. These ratings may be specific to the one user or aggregated based on other feedback received about the event. Based on this information, the determination for filtering events for a particular user may be improved. For example, Mary might attend an event hosted by Bob. Bob's event was not tasteful, in Mary's opinion. Therefore Mary may rate Bob and have the notification service no longer notify her of any events that Bob hosts.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for providing virtual world event notification, comprising:
receiving information regarding a virtual world event, the information including a date and time of the virtual world event, the information further including attributes of the virtual world event;
receiving a user profile, the user profile including a user's calendar information and attributes of virtual world events in which a user is interested;
determining if the virtual world event would be of interest to a user based upon the user profile; and
inviting a user to the virtual world event based upon the user profile through the user's calendar application.
